(19) United States
(12) Patent Application Publication
(10) Pub. No.: US 2023/0054370 A1
(43) Pub. Date: Feb. 23, 2023

(54) CONTAINER SYSTEMS THAT INCLUDE SLEEVE LABELS

(71) Applicant: The Procter & Gamble Company, Cincinnati, OH (US)

(72) Inventors: Timothy Hunn Tao Ling, Blue Ash, OH (US); Joseph Allen Berlepsch, Hamilton, OH (US); Mauro Alvarado, JR., Cincinnati, OH (US)

(21) Appl. No.: 17/884,614

(22) Filed: Aug. 10, 2022

Related U.S. Application Data
(60) Provisional application No. 63/231,357, filed on Aug. 10, 2021.

(51) Int. Cl. B65D 23/08; B65D 1/02; B65D 1/40

(52) U.S. Cl. CPC B65D 23/0871; B65D 1/0207; B65D 1/40; B65D 2203/02

(57) ABSTRACT

Container systems that include where the label is in the form of a sleeve, preferably a shrink sleeve. Consumer products that include such container systems. Arrays of consumer products, where some of the container systems include labels in the form of sleeves, and others include labels that are not in the form of sleeves. Methods of making such consumer products.

### FIELD OF THE INVENTION

The present disclosure relates to container system including a container and a label, where the label is in the form of a sleeve. The present disclosure also relates to consumer products that include such container systems and a consumer product composition in the container system. The present disclosure also relates to arrays of consumer products. The present disclosure also relates to related methods of making consumer products.

### BACKGROUND OF THE INVENTION

Consumer product compositions are ubiquitously packed in containers. During transport and/or storage of such containers, whether prior to filling or when they are full of consumer product compositions, the containers may be stacked on top of each other. When the top load forces get too excessive, the containers may buckle.

To add structural support to certain containers that are useful for containing pourable consumer product compositions, some containers, such as bottles, include surface irregularities such as facets. While these facets can provide structural support, while also being aesthetically pleasing to a consumer, the facets can cause labeling challenges. For example, when the facets cover the majority or even entire exterior surface of a container, it can be challenging to affix a traditional label, such as an in-mold label, to the container due to the irregular surface. This can be overcome by using a sleeve label, such as a shrink sleeve label, but even then the facets can cause challenges; for example, different facets may reflect light at different angles, which can make the label difficult to read without a consumer changing positions or moving the bottle around.

Furthermore, a manufacturer may not wish to add labels in the form of sleeves to all of the containers, meaning that the manufacturer will need to maintain an inventory of two different container types, those suitable for sleeves and those suitable for other types of labels. This can result in added logistical challenges, such as added time during changeover in the manufacturing process or additional storage space.

There is a need for improved container systems and related consumer products that address one or more of these challenges.

### SUMMARY OF THE INVENTION

In general, the present disclosure relates to container systems having labels in the form of sleeves, preferably shrink sleeves.

For example, the present disclosure relates to a container system having a container and a label, where the container includes a closed end having a closed end periphery, a peripheral wall extending from the closed end periphery about a longitudinal axis of the container to an open end, where the peripheral wall has a peripheral wall exterior surface oriented away from the longitudinal axis, where the peripheral wall exterior surface has a peripheral wall exterior surface area, wherein the peripheral wall exterior surface includes a first smooth panel and a textured region, where the first smooth panel does not encircle the longitudinal axis, where the textured region includes a plurality of irregularities, where each irregularity is arranged next to one or more adjacent irregularities; and where the label is in the form a sleeve, preferably a shrink sleeve, disposed about the peripheral wall.

The present disclosure also relates to a consumer product, where the consumer product includes a container system as described above, and a consumer product composition disposed in the interior volume of the container, preferably a consumer product composition selected from a fabric care composition, a home care composition, a beauty care composition, or combinations thereof, more preferably a fabric care composition.

The present disclosure also relates to an array of consumer products, where the array includes a first consumer product and a second consumer product, where the first consumer product includes a first consumer product composition disposed in a first container, where the second consumer product includes a second consumer product composition disposed in a second container, where the first and second containers are each as described above, where the first container includes a first label in the form of a sleeve, preferably a shrink sleeve, disposed about the peripheral wall, and where the second container includes a second label on the smooth panel, where the second label is not in the form of a sleeve, preferably where the second label is in the form of an in-mold label.

The present disclosure also relates to a method of manufacturing the first and second consumer products described above, where the method includes the steps of: providing the first consumer product composition to the first container; providing the label in the form of the sleeve to the peripheral wall of the first container; providing the second consumer product composition to the second container; and providing the label that is not in the form of a sleeve to the smooth panel of the second container.

### BRIEF DESCRIPTION OF THE DRAWINGS

The figures herein are illustrative in nature and are not intended to be limiting.

FIG. 1 shows a front view of a container according to the present disclosure.

FIG. 2 shows a bottom view of a container according to the present disclosure.

FIG. 3 shows a top view of container according to the present disclosure.

FIG. 4 shows a rear view of a container according to the present disclosure.

FIG. 5 shows a side view of a container according to the present disclosure.

FIG. 6 shows a container system according to the present disclosure, including a container and a label in the form of a sleeve.

FIG. 7 shows a consumer product according to the present disclosure.

FIG. 8 shows an array of consumer products according to the present disclosure.

### DETAILED DESCRIPTION OF THE INVENTION

The present disclosure relates to container systems that are suitable for use in packaging consumer products. The container systems may include a container and a sleeve, such as a shrink sleeve, which may act as a label. The containers of the present disclosure include a textured portion on an exterior surface, as well as a smooth panel.

Without wishing to be bound by theory, it is believed that the textured portion can provide one or more benefits, such as providing structural support to the container, minimizing slippage of a sleeve, and/or providing benefits during the transport of multiple containers.

Furthermore, without wishing to be bound by theory, it is believed that the smooth panel improves visibility or readability for a label that is placed thereon. The label may be part of sleeve, such as a shrink sleeve. Additionally, the smooth panel provides a convenient location onto which to affix a non-sleeve label, such as an in-mold label.

Thus, by having both textured portions and smooth panels, the containers of the present disclosure can conveniently and efficiently be used with a variety of labels, which provides flexibility to the consumer product manufacturer. When the same types of containers are differentiated by very different label styles, they can also be easily differentiated by the consumer; for example, the different label styles can signal different end-use benefits or price points.

The containers, container systems, consumer products, arrays, and related methods of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Container System

The present disclosure relates to a container system 1000, where the container system 1000 comprises a container 1 and a label 49 in the form of a sleeve 50, preferably a shrink sleeve 52.

### Container

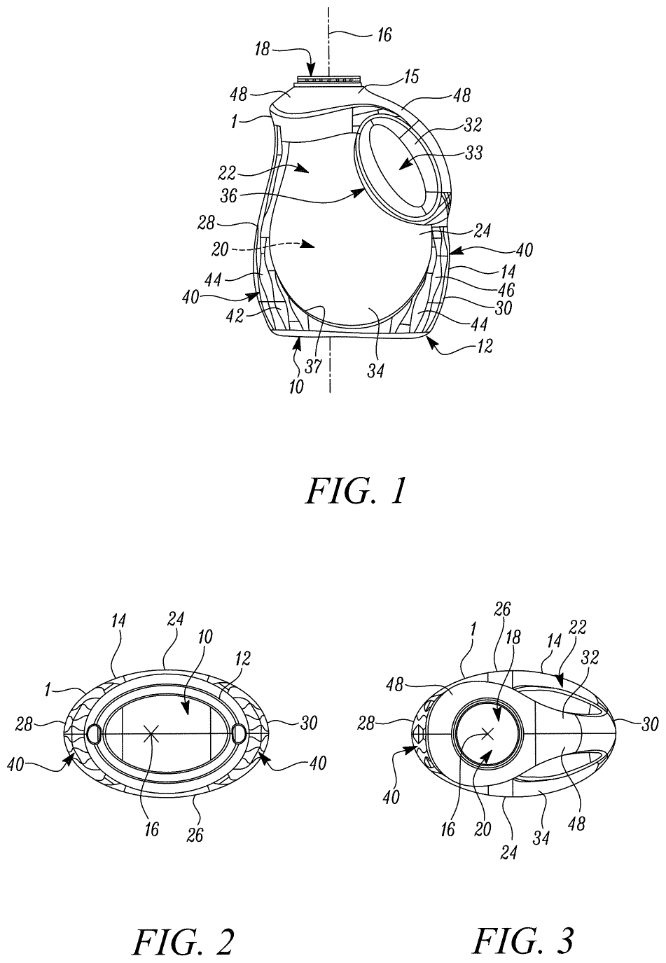

The containers 1 of the present disclosure are preferably suitable for packaging consumer product compositions 110, preferably pourable consumer product compositions. The container 1 is preferably in the form of a bottle. Suitable containers 1 according to the present disclosure are shown in FIGS. 1-4.

The container 1 is preferably a blow-molded container. The container 1 can be formed by injection stretch blow molding. The container 1 can be formed by injection molding, injection stretch blow molding, extrusion blow molding, or similar process. The container 1 can be a thermoformed container.

As shown, for example, in FIGS. 1 and 2, the container 1 comprises a closed end 10. The closed end 10 comprises a closed end periphery 12. The closed end periphery 12 can define the extent of the closed end 10 away from the longitudinal axis 16. The closed end 10 can be shaped to have a structure that can be stably rested on a flat surface such as a table.

A peripheral wall 14 extends from the closed end periphery 12 about a longitudinal axis 16 of the container 1 to an open end 18. The peripheral wall 14 can extend from the open end 18 to the closed end 10. The peripheral wall 14 can be symmetric or asymmetric about the longitudinal axis 16. The open end 18 can be about the longitudinal axis 16. If the open end 18 is generally circularly shaped, the open end 18 can circumscribe the longitudinal axis 16.

Shown, for example, in FIG. 3, the container 1 comprises an open end 18. The open end 18 may be suitable for receiving a consumer product composition 110 during a filling process and/or dispensing the consumer product composition 110 during usage.

The closed end 10 and the peripheral wall 14 define an internal volume 20, which is preferably suitable for receiving a consumer product composition 110. The internal volume 20 may be characterized by a volume of from about 0.1 L to about 10 L, preferably from about 0.25 L to about 5 L, more preferably from about 0.5 L to about 3 L, more preferably from about 0.75 L to about 3 L, even more preferably from about 1 L to about 3 L, or from about 1.5 L to about 3 L, or from about 2 L to about 3 L.

The closed end 10 and the peripheral wall 14 preferably comprise a thermoplastic material 15. The thermoplastic material can be a petroleum-based thermoplastic material or a plant-based thermoplastic material. The container 1 can comprise a material, preferably a thermoplastic material 15, selected from the group consisting of high density polyethylene, low density polyethylene, polypropylene, biaxially oriented polypropylene polyethylene, polyethylene terphthalate, polyethylene terephthalate glycol, processable polylactic acid, polyvinyl chloride, thermoplastic starch, cellulose bioplastic, aliphatic polyesters, polylactic acid, and mixtures thereof.

The thermoplastic material may comprise recycled material, regrind material, or combinations thereof. Examples of “recycled” materials may include post-consumer recycled (PCR) materials, post-industrial recycled (PIR) materials, and mixtures thereof. Examples of “regrind” material may include thermoplastic waste material, such as sprues, runners, excess parison material, and reject parts from injection and blow molding and extrusion operations, which has been reclaimed by shredding or granulating.

The peripheral wall 14 has a peripheral wall exterior surface 22. The peripheral wall exterior surface 22 is oriented away from the longitudinal axis 16. The peripheral wall exterior surface 22 may be characterized by a peripheral wall exterior surface area. As described in more detail below, the peripheral wall exterior surface 22 comprises at least a first smooth panel 34 and a textured region 40.

As shown in the views of FIGS. 2 and 3, the peripheral wall 14 may have different portions. For example, the peripheral wall 14 may comprise a front wall 24. The peripheral wall 14 may comprise a rear wall 26 that is opposite the front wall 24. The peripheral wall 14 may comprise a first side wall 28 and a second side wall 30 that connect the front wall 24 and the rear wall 26. Any corners of the container 1, for example where the front wall 24 meets a side wall 28, 30 may be rounded.

As shown in FIG. 1, the container 1 may comprise a handle 32, which may provide a convenient gripping portion. Preferably, the handle 32 is a through handle that is adjacent a throughhole 33, as shown in FIG. 1. The handle 32 may be part of the peripheral wall 14.

The handle 32 may include surface irregularities (not shown), such as bumps, dimples, ribs, contours, or combinations thereof, that may help to make the handle easier to grip.

The peripheral wall exterior surface 22 comprises a first smooth panel 34. In the present disclosure, “smooth” means a relatively continuous surface with few significant elevation changes that visually appears smooth from a distance of one meter or more, and/or a surface that provides a relatively flat surface to which a label may be applied. The first smooth panel 34 may be planar, but preferably has a curve in one or more directions, which can contribute to an aesthetically pleasing rounded shape to the container 1.

The first smooth panel 34 does not encircle the longitudinal axis 16. As shown in FIG. 1, the first smooth panel 34 may be disposed on a front wall 24 of the peripheral wall 14. This orientation allows the smooth panel 34 to be front-facing during display or selling of consumer products packaged in such containers 1, allowing for convenient reading of the labels and/or messages that may displayed thereon.

The first smooth panel 34 may have any suitable shape. The smooth panel may be substantially in the shape of a convex polygon, such as a square or rectangle. By “substantially” in this context, it is intended to include shapes that have, for example, rounded corners and/or line segments that are not quite straight. The smooth panel 34 may be in a shape that is not a convex polygon. For example, the smooth panel 34 may be in the shape of a circle, oval, ellipse, or egg-shape. The shape of the smooth panel 34 may preferably have at least one concave portion 36. As shown in FIG. 1, the concave portion 36 of the smooth panel 34 is shaped and curved to accommodate the shape of the throughhole 33. The first smooth panel 34 may have a first smooth panel periphery 37 that defines the shape of the first smooth panel 34. The first smooth panel periphery 37 may project away from the longitudinal axis 16, or fall towards the longitudinal axis 16, compared to at least one portion of the peripheral wall exterior surface 22.

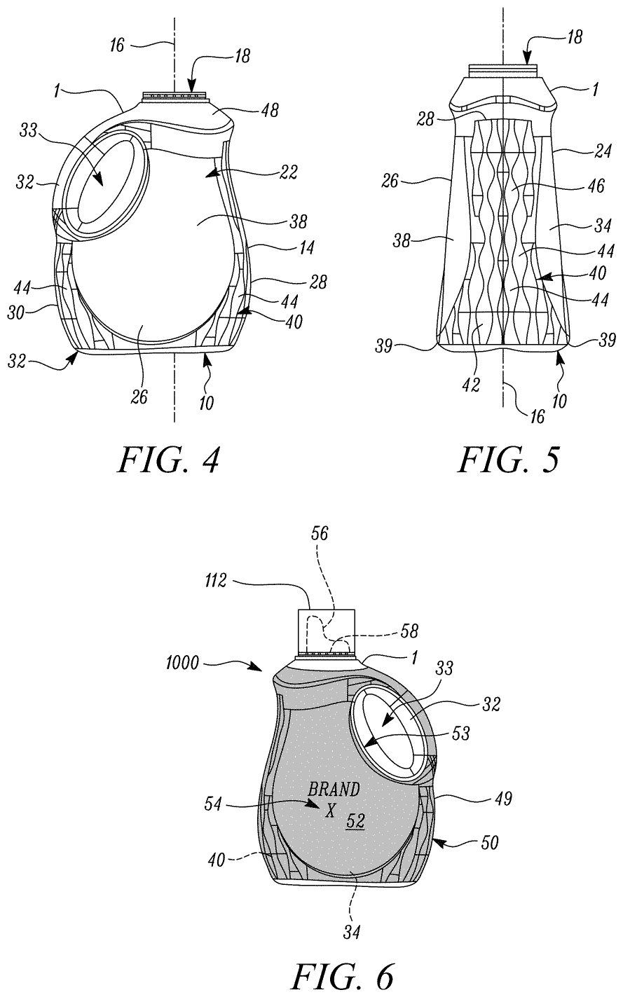

As shown in FIG. 4, the container 1 may comprise a second smooth panel 38. The second smooth panel 38 may preferably be disposed on a rear wall 26 of the container 1. The second smooth panel 38 may have any suitable shape. The second smooth panel 38 may be substantially symmetrical to the first smooth panel 34.

It is desirable for the first smooth panel 34, as well as the second smooth panel 38 if present, to be relatively large. For example, when the first smooth panel 34 has a relatively large surface area, it is particularly well-suited to display whatever messages are located thereon. The first smooth panel 34 may be characterized by a first smooth panel surface area that is from about 5% to about 50%, preferably from about 10% to about 40%, more preferably from about 15% to about 35%, of the peripheral wall exterior surface area. The surface area of the first smooth panel 34 and/or the second smooth panel 38 is preferably greater than the surface area of any individual irregularity 42, preferably any individual facet 44.

The first smooth panel 34 and/or the second smooth panel 38, preferably both, may preferably be curved about a single axis, preferably substantially an axis that extends from the closed end 10 to the open end 18, which can be, but is not necessarily, parallel to the longitudinal axis 16. For example, as can be seen in the top view of FIG. 3, the first smooth panel 34 curves outwardly away from the longitudinal axis 16, although not necessarily with a single radius of curvature, as does the second smooth panel 38. Put another way, the first smooth panel 34 and the second smooth panel are configured with an outward curve that stretches substantially from a first side wall 28 to a second side wall 30. It is preferred that the first smooth panel 34, and preferably also the second smooth panel 38, is curved only about a single axis in order to facilitate better application of non-sleeve labels; curvatures about multiple axes can result in uneven or wrinkled application of such labels.

The peripheral wall exterior surface 22 comprises a textured region 40. The textured region 40 comprises a plurality of irregularities 42. Each irregularity 42 is arranged next to one or more adjacent irregularities 42, thereby forming a textured surface that has a different, rougher texture or topography than that of the smooth panel 34. FIG. 5 shows a side view of a container 1 according to the present disclosure, where a suitable textured region 40 is conveniently visible on a first side wall 28.

As described above, the irregularities 42 of the textured region 40 may provide one or more benefits. For example, the irregularities 42 may contribute to additional structural support or strength, giving the container 1 an improved ability to bear top load forces. The irregularities 42 may improve the registration of any sleeves applied to the container 1, such as a shrink sleeve, and/or result in relatively less slippage of such sleeves. Containers 1 having a textured region 40 as described herein may provide a better gripping surface compared to smooth surfaces, making them easier to manufacture, fill, seal, or place into secondary packaging, for example by robot arms. The textured regions 40 and/or the irregularities 42 thereof may provide advantages during storage or shipping of such containers 1. For example, when rounded containers are stored or transported next to each other in a case, the small points of contact between the containers can result in relatively high pressure points, which may dent the containers or rub off the artwork on a shrink sleeve; relatively flat irregularities 42, such as the facets 44 described below, may provide relatively larger surface areas at these points of contact, leading to less pressure at any one point and fewer problems. Flat points of contact between containers 1 can also reduce shifting or “shingling” of the containers 1 when transported a case.

The plurality of irregularities 42 may take on a variety of forms, or even mixtures of forms. That being said, the plurality of irregularities 42 may comprise a plurality of facets 44. Put another way, a given irregularity 42 may be in the form of a facet 44. A facet 44 may be a small plane surface. A facet 44 may preferably be adjacent to at least one other facet 44.

As described above, facets 44 can provide one or more advantages due to their relatively flat surface area. The textured region 40 may comprise more than about five facets 44, preferably more than about ten facets 44, more preferably more than about twenty facets 44. A textured region 40 may comprise from about five, preferably from about ten, to about fifty facets 44.

To note, while a facet 44 may be characterized by a relatively flat or smooth surface, the facets 44 are to be distinguished from the smooth panel(s) 34, 38. For example, a given facet 44 is relatively smaller (e.g., is characterized by a smaller surface area) than the smooth panel(s) 34, 38. Additionally, the facets 44 are arranged adjacent to one or more other facets 44, whereas the first smooth panel 34 is typically not adjacent to a second smooth panel 38. Taken together, the facets 44 may make up some or all of the textured region 40 of the peripheral wall exterior surface.

Each of the facets 44 may preferably have a shape that is substantially polygonal. As above, the term “substantially” in this context is intended to include shapes that have, for example, rounded corners and/or line segments that are not quite straight. The substantially polygonal shape may be selected from the group consisting of substantially triangular, substantially quadrilateral, substantially pentagonal, substantially hexagonal, and combinations thereof. The facets 44 may have a substantially polygonal shape that is substantially quadrilateral, such as square, rectangular, or rhomboid. The plurality of facets 44 may include facets of different shapes and/or sizes.

Each of the facets 44 has a facet exterior surface 46 oriented away from the longitudinal axis 16. Some, preferably each and all, of the facets may have a facet exterior surface area that is between about 0.0001% and about 4% of the peripheral wall exterior surface area, preferably from about 0.001% to about 2%. Different facets 44 may be characterized by different facet exterior surface areas. A plurality of facets 44 may be arranged so that individual facets 44 present facet exterior surfaces 46 that reflect incident light in different directions; put another way, the orthogonal directions away from the facet exterior surfaces 46 are divergent.

It is preferable that textured region 40 is present at a certain minimum surface area of the container 1 so that there is enough of the textured region 40 present to provide one or more of the advantages listed. On the other hand, it may be desirable to keep the textured region below a certain maximum surface area of the container 1 so that the first smooth panel 34 (and optionally a second smooth panel 38) also has plenty of surface area from which to display the manufacturer's desired messaging. For example, the textured region 40 may have a textured region surface area that is from about 5% to about 50%, preferably from about 10% to about 40%, more preferably from about 15% to about 35%, of the peripheral wall exterior surface area. It may be preferred that the total surface area of the first smooth panel 34 and any other smooth panel if present (e.g., a second smooth panel 38) is greater than the textured region surface area.

The textured region 40 may be present at any suitable portion of the peripheral wall 14. The textured region 40 may be present on a front wall 24, a rear wall 26, a first side wall 28, a second side wall 30. Preferably, the textured region 40 is present at least on the first side wall 28 and the second side wall 30. Put another way, the first and/or second side walls 28, 30 may comprise a plurality of irregularities 42. The front and/or rear walls 24, 26 may comprise a plurality of irregularities. The first and/or second side walls 28, 30 may comprise a greater number of irregularities compared to the front and/or rear walls 24, 26. The peripheral wall exterior surface area of the first and/or second side walls 28, 30 that includes irregularities 42 may be relatively greater than the peripheral wall exterior surface area of the front and/or rear walls 24, 26 that includes irregularities 42. The container 1 may comprise more than one textured region 40.

As also can be seen from FIG. 5, the general shape of the container 1 may taper inwardly with respect from the closed end 10 of the container 1 towards the open end 18. For example, the front and back walls 24, 26 may be configured to taper inwards, e.g., towards the longitudinal axis 16, near the open end 18 of the container 1. Such a configuration can contribute to structural strength of the container 1, for example making it more resistant to top load forces.

Near the closed end 10, the container 1 may include a lip 39 that curves from an outwardly projecting position inwardly towards the longitudinal axis 16. The lip 39 may be part of any of the front wall 24, rear wall 26, first side wall 28, second side wall 30, or a combination thereof, preferably at least two of those, more preferably all four. The lip 39 may be configured to project more radially outward than the closed end periphery 12. The lip 39 can help to improve the positioning and/or prevent slippage of the sleeve 50.

In addition to the smooth panels 34, 38, the peripheral wall exterior surface may comprise other smooth regions 48 that are distinct from smooth panels 34, 38 and from the textured region 40. The other smooth regions 48 may encircle the longitudinal axis 16. The other smooth regions 48 may be near to the closed end 10 and/or the open end 18. The handle 32 may comprise other smooth regions 48.

### Sleeve

FIG. 6 shows a container system 1000 according to the present disclosure, where a label 49 in the form of a sleeve 50 is disposed about a peripheral wall 14 of a container 1.

The container system 1000 comprises a label 49 in the form of a sleeve 50. The sleeve 50 is disposed about the peripheral wall 14 of the container 1. The sleeve 50 is preferably a shrink sleeve 52, which may be heat-shrunk around the container 1. Alternatively, the sleeve 50 may be a stretch sleeve into which a pre-form or parison is blown to stretch the stretch sleeve to form the container system 1000.

The sleeve 50 may include thermoplastic materials 15, such as polyvinyl chloride (PVC), polyester terephthalate (PET), oriented polypropylene (OPP), and oriented polystyrene (OPS). The shrink sleeve 50 may comprise one layer or a plurality of layers, such as laminated layers. The plurality of layers may include a first layer and a second layer, where the first and second layers may be made from different materials. For example, an outer layer may be selected to be suitable to be printed upon.

The sleeve 50 may be printed. The sleeve 50 may be reverse printed. The sleeve 50 can be printed by digital printing, flexographic printing, gravure printing, or other suitable printing technology.

The printing may comprise a metallic ink or pearlescent ink. A metallic foil can be included in a laminate of the sleeve 50. A metallic ink comprises small particles of metal, such as aluminum, bronze, copper, zinc, or other metallic element. A sleeve 50 that is printed with a metallic ink can provide for a reflective surface that that generates more intense perceived flashes of reflectance.

The sleeve 50, preferably a shrink sleeve 52, may comprise indicia 54. Suitable indicia 54 may include marketing information (such as a brand name), a graphic (such as a logo or decoration), instructional information, safety information, or a combination thereof.

The sleeve 50 may comprise one or more apertures 53. The one or more apertures 53 may be aligned with the throughhole 33 of a handle 32. The one or more apertures 53 may be formed by any suitable process. Typically, a cutting process is used to cut or score the sleeve 50, and a predetermined removeable portion is removed, thereby forming the aperture 53. The cutting process may include cutting by a cutter, such as a laser, a blade, a die, or other tooling capable of cutting a predetermined removeable portion from the sleeve 50. The removal process may include removal by a striker, by vacuum, or by other suitable means. The cutting and/or removal process may occur before or after the sleeve 50 has been provided to the container 1.

The sleeve 50 may include a lower edge 55 that is positioned near the closed end 10 of the container 1 when the sleeve 50 is disposed on the container. The lower edge 55 of the sleeve 50 may be positioned below the lip 39 of the container (e.g., closer to the closed end 10 than the lip 39 is), or at least below the most outwardly projecting part of the lip 39. The lip 39 helps to keep the sleeve 50 in place and/or prevent “smiling”, in which the lower edge 55 curves upwards during, for example, a shrink-wrapping process.

### Additional Portions

The container system 1000 may include a spout 56 to facilitate dispensing of the consumer product compositions. The container system 1000 may comprise a transition piece 58. The spout 56 may be part of the transition piece 58.

The container system 1000 may comprise a closure 112, which may be in the form of a dosing cup. The closure 112 may be a plug seal closure that is operatively engageable with the open end. The closure 112 may be threadably engageable with the container 1 and/or transition piece 58.

### Consumer Product

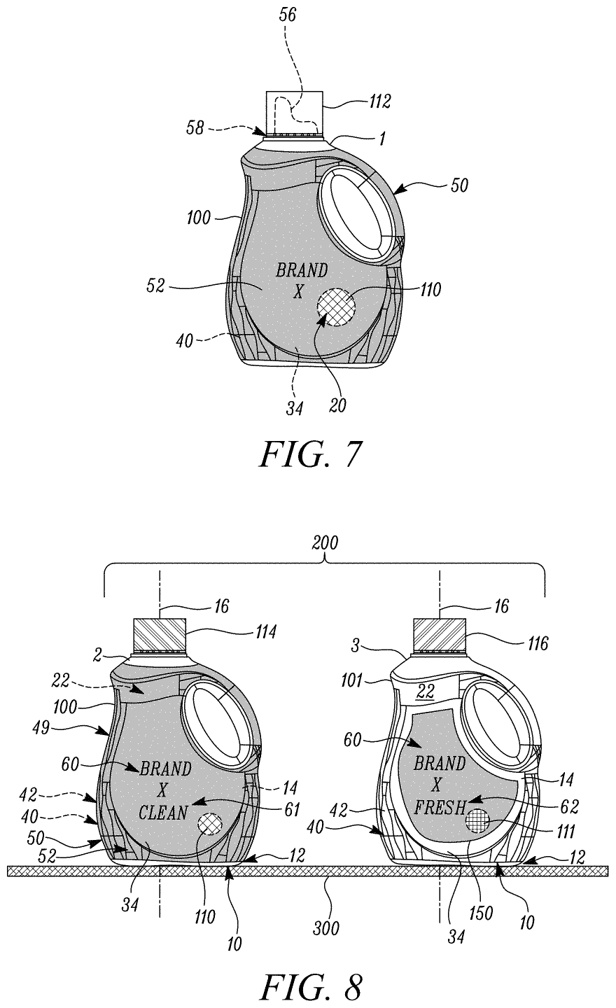

The present disclosure relates to a consumer product 100. FIG. 7 shows a suitable consumer product 100. The consumer product 100 comprises a container system 1000 as described herein, and a consumer product composition 110 disposed in an internal volume 20 of the container 1 (shown as a cut-away view). The container system 1000 includes a sleeve 50 in the form of a shrink sleeve 52.

The consumer product 100 may comprise a closure 112 that seals the open end of the container 1. The closure 112 may be in the form of a cap, which may be threadably engageable with the container 1, such as a transition piece 58 if present. The closure 112 may also serve as a measuring and/or dosing device when using the consumer product composition 110.

The consumer product may be a fabric care product, a home care product, a beauty care product, or a combination thereof, preferably a fabric care product. Thus, the consumer product composition may be a fabric care composition, a home care composition, a beauty care composition, or a combination thereof, preferably a fabric care composition.

The consumer product composition is preferably a fabric care composition, such as a laundry detergent composition (including a heavy-duty liquid washing detergent), a fabric conditioning composition (including a liquid fabric softening and/or enhancing composition), a laundry additive, a fabric pre-treat composition (including a pourable liquid, or a mixture thereof. Preferably, the fabric care composition is a fabric conditioning composition.

The composition may be a home care composition, such as an air care, car care, dishwashing, hard surface cleaning and/or treatment, and other cleaning for consumer or institutional use.

The composition may be a beauty care composition, such as a hair treatment product (including shampoo and/or conditioner), a skin care product (including a cream, lotion, or other topically applied product for consumer use), a shave care product (including a shaving lotion, foam, or pre- or post-shave treatment), personal cleansing product (including a liquid body wash or a liquid hand soap), or mixtures thereof.

The consumer product composition 110 may be in the form of a liquid composition, a granular composition, a pastille or bead, or a mixture thereof. It is preferred that the consumer product composition 110 can be poured out of the container 1.

The consumer product composition 110 is preferably in the form of a liquid. The liquid composition may include from about 30%, or from about 40%, or from about 50%, to about 99%, or to about 95%, or to about 90%, or to about 75%, or to about 70%, or to about 60%, by weight of the composition, of water. The liquid composition may be a liquid laundry detergent, a liquid fabric conditioner, a liquid dish detergent, a hair shampoo, a hair conditioner, or a mixture thereof. The composition may have a viscosity of from 1 to 1500 centipoises (1-1500 mPa*s), from 100 to 1000 centipoises (100-1000 mPa*s), or from 200 to 500 centipoises (200-500 mPa*s) at 20 s⁻¹ and 21° C.

The composition may be in the form of a solid, preferably one that is pourable. The solid composition may be a powdered or granular composition. Such compositions may be agglomerated or spray-dried. Such composition may include a plurality of granules or particles, at least some of which include comprise different compositions. The composition may be a powdered or granular cleaning composition, which may include a bleaching agent. The composition may be in the form of a bead or pastille, which may be pastilled from a liquid melt. The composition may be an extruded product.

The consumer product composition may comprise one or more suitable consumer product adjuncts materials (also “adjuncts” as used herein). The consumer product adjunct material may provide a benefit in the intended end-use of a composition, or it may be a processing and/or stability aid.

Suitable consumer product adjunct materials may include: surfactants, conditioning actives, deposition aids, rheology modifiers or structurants, bleach systems, stabilizers, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, silicones, hueing agents, aesthetic dyes, additional perfumes and perfume delivery systems, structure elasticizing agents, carriers, hydrotropes, processing aids, anti-agglomeration agents, coatings, formaldehyde scavengers, and/or pigments.

Depending on the intended form, formulation, and/or end-use, compositions of the present disclosure might not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids, structurants, anti-agglomeration agents, coatings, formaldehyde scavengers, and/or pigments.

The precise nature of these additional components, and levels of incorporation thereof, will depend on the physical form of the composition and the nature of the operation for which it is to be used. However, when one or more adjuncts are present, such one or more adjuncts may be present as detailed below. The following is a non-limiting list of suitable additional adjuncts.

The consumer product compositions 110 of the present disclosure may comprise surfactant. Surfactants may be useful for providing, for example, cleaning benefits. The compositions may comprise a surfactant system, which may contain one or more surfactants. The compositions of the present disclosure may include from about 0.1% to about 70%, or from about 2% to about 60%, or from about 5% to about 50%, by weight of the composition, of a surfactant system. The surfactant system may include anionic surfactant, nonionic surfactant, zwitterionic surfactant, cationic surfactant, amphoteric surfactant, or combinations thereof. The surfactant system may include linear alkyl benzene sulfonate, alkyl ethoxylated sulfate, alkyl sulfate, nonionic surfactant such as ethoxylated alcohol, amine oxide, or mixtures thereof. The surfactants may be, at least in part, derived from natural sources, such as natural feedstock alcohols.

The consumer product compositions 110 of the present disclosure may include a conditioning active. Compositions that contain conditioning actives may provide softness, anti-wrinkle, anti-static, conditioning, anti-stretch, color, and/or appearance benefits. The consumer product composition may comprise from about 1% to about 50%, preferably from about 4% to about 35%, more preferably from about 5% to about 20%, more preferably from about 6% to about 15%, by weight of the consumer product composition, of a conditioning active. Conditioning actives suitable for compositions of the present disclosure may include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof. The composition may include a quaternary ammonium ester compound, a silicone, or combinations thereof, preferably a combination.

The consumer product compositions 110 of the present disclosure may comprise a perfume system. The perfume systems may comprise neat perfume oil, pro-perfumes, encapsulated perfumes, polymer-assisted-delivery perfumes, or combinations thereof. Encapsulated perfumes may include populations of core/shell delivery particles, wherein the core comprises perfume and optionally a partitioning modifier (such as isopropyl myristate), and the shell comprises a polymeric material, such as a polyacrylate, a polymethacrylate, a polyamide, a polyamide ester, a polyurea, a polyurethane, a melamine-formaldehyde, a biopolymer (such as a polysaccharide), and the like. Pro-perfumes may include silicone-based pro-perfumes.

The consumer product compositions 110 of the present disclosure may include deposition aids, such as cationic polymers. The consumer product compositions 110 of the present disclosure may include structurants or rheology modifiers.

### Array

The present disclosure relates to an array 200 of consumer products 100, 101. An array 200 according to the present disclosure is shown in FIG. 8.

In general, the consumer products 100, 101 comprise similar containers 1, where the containers 1 are substantially the same as those described above, e.g., each having a textured portion 40 and one or more smooth panels 34. However, the consumer products 100, 101 are differentiated by different label types—at least one consumer product 100 comprises a sleeve 50, preferably a shrink sleeve 52, while at least one other consumer product 101 comprises a different type of label 150 that is not in the form of a sleeve.

The usage of different types of labels can prove useful to the consumer, enabling them to conveniently differentiate between products that are packaged in similar containers, but for the labels. For example, the consumer products may provide different benefits, have different aesthetics, or be at different price points. The containers 1 of the present disclosure are particularly well-suited to receive different types of labels, due to the presence of both a textured region 40 and a smooth panel 34.

The arrays 200 of the present disclosure relate to arrays 200 of consumer products, where the array 200 comprises a first consumer product 100 and a second consumer product 101. The first consumer product 100 comprises a first consumer product composition 110 disposed in a first container 2. The second consumer product 101 comprises a second consumer product composition 111 disposed in a second container 3. Suitable containers and consumer products are described in more detail above, and the disclosure in those sections substantially applies to the containers and consumer products the presently described arrays.

For example, in the arrays of the present disclosure, the first container 2 and the second container 3 each comprise: a closed end 10 having a closed end periphery 12, a peripheral wall 14 extending from the closed end periphery 12 about a longitudinal axis 16 of the container 2, 3 to an open end 18, wherein the peripheral wall 14 has a peripheral wall exterior surface 22 oriented away from the longitudinal axis 16, wherein the peripheral wall exterior surface 22 has a peripheral wall exterior surface area, wherein the peripheral wall exterior surface 22 comprises a first smooth panel 34 and a textured region 40, wherein the first smooth panel 34 does not encircle the longitudinal axis 16, wherein the textured region 40 comprises a plurality of irregularities 42, wherein each irregularity 42 is arranged next to one or more adjacent irregularities 42. It is preferred that the first and second containers 2, 3 are blow-molded containers made from a thermoplastic material 15, as described in more detail above.

As indicated above, the first and second containers 2, 3, include different types of labels. For example, the first container 2 comprises a first label 49 in the form of a sleeve 50 disposed about the peripheral wall 14, preferably wherein the sleeve 50 is in the form of a shrink sleeve 52. Shrink sleeves 52 are described in more detail above.

The second container 3 comprises a second label 150 on the smooth panel 34, wherein the second label 150 is not in the form of a sleeve. The second label 150 may be selected from the group consisting of an in-mold label, a heat-transfer label, an adhesive label, a direct-printed label, or a combination thereof, preferably an in-mold label. In particularly, second labels 150 in the form of in-mold labels are conveniently applied to the smooth panels 34 of blow-molded containers.

The first and second consumer products 100, 101 may comprise different consumer product compositions 110, 111, but the first and second labels 49, 150 may preferably comprise a common indicia 60, such as marketing information (e.g., a brand name), a graphic (e.g., a logo or decoration), instructional information, safety information, or a combination thereof. Such common indicia 60 can help tie the consumer products 100, 101 together in the consumer's mind. Additionally or alternatively, the first label 49 may comprise first indicia 61 and the second label 150 may comprise second indicia 62 that is different from the first indicia 61. This can help further help a consumer to differentiate the consumer products 100, 101.

The first consumer product composition 110 and the second consumer product composition 111 preferably have different formulations. For example, the formulations may include different ingredients, an ingredient that is present in one but not the other, or a common ingredient that is present at different levels in each. The first and second consumer products 100, 101 may be different versions of the same or similar type of product; for example, they may be two versions of fabric enhancer products, e.g., with different levels of actives. Additionally or alternatively, the first and second consumer products 100, 101 may be suitable for using in series, for example as part of a treatment regimen; as an example, the first consumer product 100 may be useful as a laundry detergent intended to be used in a wash cycle, while the second consumer product 101 may be useful as a fabric enhancer to be used in a rinse cycle.

For example, in the arrays 200 of the present disclosure, the first consumer product composition 110 and the second consumer product composition 111 may each comprise a first consumer product adjunct material in common. The first consumer product adjunct material may be any suitable consumer product adjunct material, preferably surfactant, a conditioning agent, a perfume system, or a mixture thereof. Preferably the first consumer product adjunct material is present in both the first and second consumer product compositions at a level of from about 4 wt % to about 35 wt %, although the wt %'s may be the same or different.

The first consumer product composition 110 may comprise the first consumer product adjunct material at a first wt % (i.e. present at a weight percent, by weight of the first consumer product composition), and the second consumer product composition 111 may comprise the first consumer product adjunct material at a second wt % (i.e. present at a weight percent, by weight of the second consumer product composition) that is different than the first wt %. Preferably, the first wt % is greater than the second wt %.

The first consumer product adjunct material is preferably a conditioning agent, more preferably a quaternary ammonium ester material.

The first and second consumer product compositions 110, 111 may comprise different perfume systems. The perfume systems may comprise neat perfume oil, pro-perfumes, encapsulated perfumes, polymer-assisted-delivery perfumes, or combinations thereof. The perfume systems may comprise different perfume raw materials, delivery systems, or levels thereof. In the present disclosure, “different perfume systems” is also understood to mean that the first and second consumer product compositions could comprise the same perfume materials, but at different wt % levels.

Preferably, the first and second consumer product compositions 110, 111 are both liquids. Liquid compositions are conveniently dispensed from the containers of the present disclosure.

Preferably, the first and second consumer products 100, 101 are in the same consumer product category. For example, the first and second consumer product compositions 110, 111 may both preferably be fabric care compositions, home care compositions, or beauty care compositions, preferably both fabric care compositions, more preferably both fabric conditioning compositions. When the first and second consumer products 100, 101 are in the same consumer product category, it is important to signal product differences to the consumer, for example through the use of different labels 49, 150.

The first and second consumer products 100, 101 are preferably displayed on a common shelving system 300, for example, vertically and/or horizontally aligned, preferably in a commercial setting. The first and second consumer products 100, 101 may be separated by less than about two meters, preferably by less than about one meter. The different labels on the similar containers will help the consumer differentiate between the consumer products and select the one that is right for him or her.

In addition to having different label types, the first and second containers 2, 3 may include different closures. For example, the first container 2 may comprise a first closure 114, and the second container 3 may comprise a second closure 116. The second closure 116 may be different than the first closure 114. The first closure 114 and the second closure 116 may be characterized by different sizes, different shapes, different colors, or a combination thereof. Visually different closures may further help the consumer to differentiate between the products. Differently sized closures may be useful for driving dosing compliance (and optimal performance) when the closure also operates as a measuring or dosing device; for example, the first and second product compositions 110, 111 may comprise an active ingredient at different levels and therefore may have different dosing recommendations.

The array may further comprise a third consumer product, which may contain a third consumer product composition in a third container. The third container may comprise a sleeve, preferably a shrink sleeve, disposed on a peripheral wall. The third consumer product composition may have formula that is substantially similar, or even the same, as the first consumer product composition. The third container may be of a different size, or have a different internal volume, compared to that of the first container. The third container may have some of, or even substantially all of, the same features as the first container, which may include a first smooth panel. Alternatively, the third container may have at least some different features compared to the first container, for example having no first smooth panel and/or having the textured region extend over a relatively greater surface area, preferably most or even all of the surface area of the container, where the textured region comprises a plurality of irregularities, preferably facets. The third container may comprise facets over most or even substantially all of the peripheral wall. An array according to the present disclosure may comprise a first consumer product (including a first container) and a third consumer product (including a third container) according to present disclosure. In such an array, a second consumer product (including a second container that has a label that is not in the form of a sleeve) may be present, or it may be absent.

### Methods of Making

The present disclosure relates to methods of making a consumer product 100. For example, the method may include providing a container 1 as described above, providing a consumer product composition 110 as described above to the internal volume 20 of the container 1 (e.g., filling the container with a consumer product composition), sealing the container, and providing a sleeve 50, preferably a shrink sleeve 52, to the peripheral wall 14 of the container 1.

The filling, sealing, and “sleeving” steps may occur in any suitable order, with the proviso that the filling step occurs prior to the sealing step. For example, the sleeve 50 may be provided to the container 1 before the consumer product composition 110 is provided to the container 1. The sleeve 50 may be provided to the container 1 prior to the container 1 being sealed. The container 1 may be sealed prior to the sleeve 50 being provided to the container 1.

A method may include removing a portion of the sleeve 50 to form an aperture 53, preferably wherein the aperture 53 is aligned with the throughhole 33 of a handle 32. A cutting process may be used, such as cutting by a cutter, such as a laser, a blade, a die, or other tooling capable of cutting a predetermined removeable portion from the sleeve 50. The removal process may include removal by a striker, by vacuum, or by other suitable means. The cutting and/or removal process may occur before or after the sleeve 50 has been provided to the container 1.

The present disclosure also relates to methods of making a plurality of consumer products, for example a first consumer product 100 and a second consumer product 101. The methods include using similar containers 2, 3 but filling them with different consumer product compositions 110, 110 and applying different types of labels 49, 150 (e.g., a sleeve to one, a non-sleeve to another).

The containers 1 of the present disclosure are particularly well-suited to such processes. For example, the containers 1 are compatible with a sleeve 50 (e.g., a shrink sleeve 52) due to the container's textured region 40, but also with a non-sleeve (e.g., a label 150 in the form of an in-mold label) due to the container's smooth panel 34. Thus, the manufacturer can conveniently use a single type of container 1 type to package multiple consumer product compositions 110, 111, where the resulting products are differentiated, at least in part, by different labels 49, 150.

The present disclosure relates to a method of manufacturing a consumer product 100 that is a first consumer product, and a second consumer product 101 as described herein. The method may include providing a first consumer product composition 110 to a first container 2, and providing a first label 49 in the form of a sleeve 50 to the peripheral wall 14 of the first container 2. These steps may occur in any suitable order, but preferably the provision of the first label 49 occurs after the first container 2 is filled with the first composition 110, for example to avoid spills onto the label 49. The method may include a step of sealing the first container 2, preferably with a first closure 114. A portion of the sleeve 50 may be removed to form an aperture 53, as described in more detail above.

The method may include the steps of providing a second consumer product 111 to a second container 3, and providing a second label 150 that is not in the form of a sleeve to the smooth panel 34 of the second container 3, preferably wherein the smooth panel 34 is disposed on a front wall of the peripheral wall. These steps may occur in any suitable order, but preferably the provision of the second label 150 occurs after the second container is filled with the second composition 111, for example to avoid spills onto the label 150. The method may include a step of sealing the second container 3, preferably with a second closure 116, which may be different from the first closure 114.

As discussed above, an advantage of the presently disclosed containers is the flexibility they offer to the manufacturer, who can use the same container with a variety of label types in combination with a variety of consumer product compositions. This provides storage convenience to the manufacturer, who only needs, for example, a single location in which to store the containers prior to being filled. Thus, the method may include the step of storing the first and second containers 2, 3 at a first location. The method may include moving the first container 2 to a first manufacturing line, and moving the second container 3 to a second manufacturing line; this is convenient when the first and second consumer products 100, 101 are made on different lines. The method may include moving the first container 2 to a first manufacturing line, and moving the second container 3 to the second manufacturing line; this is convenient when the first and second consumer products 100, 101 are made on the same line.

The first and second consumer products 100, 101 may be packaged in secondary packaging, such as a case, a crate, or a pallet. The first and second consumer products may be packaged in the same secondary packaging (e.g., placed into the same box and/or onto the same pallet), or they may be packaged in different secondary packaging (e.g., placed into different boxes and/or placed onto different pallets).

### COMBINATIONS

Specifically contemplated combinations of the disclosure are herein described in the following lettered paragraphs. These combinations are intended to be illustrative in nature and are not intended to be limiting.

A. A container system comprising a container and a label, wherein the container comprises: a closed end having a closed end periphery, a peripheral wall extending from the closed end periphery about a longitudinal axis of the container to an open end, wherein the peripheral wall has a peripheral wall exterior surface oriented away from the longitudinal axis, wherein the peripheral wall exterior surface has a peripheral wall exterior surface area, wherein the peripheral wall exterior surface comprises a first smooth panel and a textured region, wherein the first smooth panel does not encircle the longitudinal axis, wherein the textured region comprises a plurality of irregularities, wherein each irregularity is arranged next to one or more adjacent irregularities; and wherein the label is in the form a sleeve disposed about the peripheral wall.

B. The container system according to paragraph A, wherein the sleeve is a shrink sleeve, preferably a shrink sleeve comprising ink, more preferably comprising metallic ink.

C. The container system according to any of paragraphs A or B, wherein the smooth panel is disposed on a front wall of the peripheral wall.

D. The container system according to any of paragraphs A-C, wherein the smooth panel has a shape that is not a convex polygon.

E. The container system according to any of paragraphs A-D, wherein the container comprises a second smooth panel, preferably wherein the second smooth panel is disposed on a rear wall of the peripheral wall, wherein the rear wall is opposite a front wall, more preferably wherein the second smooth panel is symmetrical to the first smooth panel.

E2. The container system according to any of paragraphs A-E, wherein the first smooth panel is curved about a single axis, preferably wherein the second smooth panel is also curved about a single axis, which may be the same single axis about which the first smooth panel is curved, more preferably wherein either or both singles axes extend from the closed end to the open end of the container.

F. The container system according to any of paragraphs A-E2, wherein the peripheral wall comprises side walls that connect a front wall to a back wall, wherein at least a portion of the irregularities are disposed at least one, preferably two, side walls.

G. The container system according to any of paragraphs A-F, wherein the closed end and the peripheral wall comprise a thermoplastic material, preferably wherein the thermoplastic material comprises a material selected from the group consisting of high density polyethylene, low density polyethylene, polypropylene, biaxially oriented polypropylene polyethylene, polyethylene terphthalate, polyethylene terephthalate glycol, processable polylactic acid, polyvinyl chloride, thermoplastic starch, cellulose bioplastic, aliphatic polyesters, polylactic acid, and mixtures thereof.

H. The container system according to any of paragraphs A-G, wherein the container is a blow-molded container.

I. The container system according to any of paragraphs A-H, wherein the first smooth panel has a first smooth panel surface area that is from about 5% to about 50%, preferably from about 10% to about 40%, more preferably from about 15% to about 35%, of the peripheral wall exterior surface area.

J. The container system according to any of paragraphs A-I, wherein the textured region has a textured region surface area that is from about 5% to about 50%, preferably from about 10% to about 40%, more preferably from about 15% to about 35%, of the peripheral wall exterior surface area.

K. The container system according to any of paragraphs A-J, wherein the plurality of irregularities comprises a plurality of facets, preferably wherein each of the facets have a shape that is substantially polygonal, more preferably wherein the substantially polygonal shape is selected from the group consisting of substantially triangular, substantially quadrilateral, substantially pentagonal, substantially hexagonal, and combinations thereof, even more preferably substantially quadrilateral.

L. The container system according to paragraph K, wherein each of the facets has a facet exterior surface oriented away from the longitudinal axis, and each of the facets has a facet exterior surface area that is between about 0.0001% and about 4% of the peripheral wall exterior surface area.

M. The container system according to any of paragraphs A-L, wherein the container comprises a handle, preferably a through handle.

N. A consumer product, wherein the consumer product comprises: the container system according to any of paragraphs A-M, and a consumer product composition disposed in the interior volume of the container, preferably a consumer product composition selected from a fabric care composition, a home care composition, a beauty care composition, or combinations thereof, more preferably a fabric care composition.

O. An array of consumer products, wherein the array comprises a first consumer product and a second consumer product, wherein the first consumer product comprises a first consumer product composition disposed in a first container, wherein the second consumer product comprises a second consumer product composition disposed in a second container, wherein the first container and the second container each comprise: a closed end having a closed end periphery, a peripheral wall extending from the closed end periphery about a longitudinal axis of the container to an open end, wherein the peripheral wall has a peripheral wall exterior surface oriented away from the longitudinal axis, wherein the peripheral wall exterior surface has a peripheral wall exterior surface area, wherein the peripheral wall exterior surface comprises a first smooth panel and a textured region, wherein the first smooth panel does not encircle the longitudinal axis, wherein the textured region comprises a plurality of irregularities, wherein each irregularity is arranged next to one or more adjacent irregularities; wherein the first container comprises a first label in the form of a sleeve disposed about the peripheral wall, preferably wherein the sleeve is in the form of a shrink sleeve, and wherein the second container comprises a second label on the smooth panel, wherein the second label is not in the form of a sleeve.

P. The array according to paragraph O, wherein the second label is selected from the group consisting of an in-mold label, a heat-transfer label, an adhesive label, a direct-printed label, or a combination thereof, preferably an in-mold label.

Q. The array according to any of paragraphs O or P, wherein the first consumer product composition and the second consumer product composition each comprise a first consumer product adjunct material in common, preferably wherein the first consumer product adjunct material is present in both the first and second consumer product compositions at a level of from about 4 wt % to about 35 wt %, more preferably wherein the first consumer product composition comprises the first consumer product adjunct material at a first wt % and the second consumer product composition comprises the first consumer product adjunct material at a second wt % that is different than the first wt %, even more preferably wherein the first wt % is greater than the second wt %.

R. The array according to paragraph Q, wherein the first consumer product adjunct material is a quaternary ammonium ester material.

S. The array according to any of paragraphs O-R, wherein the first and the second labels each comprise a common indicia, preferably a common indicia selected from marketing information, a graphic, instructional information, safety information, or a combination thereof.

T. The array according to any of paragraphs O-S, wherein the first and second consumer product compositions comprise different perfume systems.

U. The array according to any of paragraphs O-T, wherein the first and second consumer product compositions are both liquids.

V. The array according to any of paragraphs O-U, wherein the first and second consumer product compositions are both fabric care compositions, home care compositions, or beauty care compositions, preferably fabric care compositions.

W. The array according to any of paragraphs O-V, wherein the first and second consumer products are displayed on a common shelving system, preferably in a commercial setting.

X. The array according to any of paragraphs O-W, wherein the first container comprises a first closure, wherein the second container comprises a second closure, and wherein the first and the second closures are characterized by different sizes, different shapes, different colors, or a combination thereof.

Y. A method of manufacturing the first and second consumer products according to any of paragraphs N-X, wherein the method comprises the steps of: providing the first consumer product composition to the first container; providing the label in the form of the sleeve to the peripheral wall of the first container; providing the second consumer product composition to the second container; and providing the label that is not in the form of a sleeve to the smooth panel of the second container.

### EXAMPLES

The examples provided below are intended to be illustrative in nature and are not intended to be limiting.

### Example 1. Exemplary Consumer Product Compositions (Liquid Fabric Enhancers)

Table 1 shows exemplary formulations of consumer product compositions that may be packaged in the container systems of the present disclosure to form consumer products. Specifically, the following compositions are liquid fabric enhancer products.

TABLE 1

| | % Active (w/w) | | |
|---|---|---|---|
| Ingredient | Composition 1 | Composition 2 | Composition 3 |
| Quaternary ammonium | 5% (Ester | 7% (Ester | 8% (Ester |
| ester material | Quat 1)¹ | Quat 2)² | Quat 3)³ |
| Delivery Particles* | 0.25% | 0.25% | 0.25% |
| (w/encapsulated | | | |
| fragrance) | | | |
| Formic Acid | 0.045% | 0.045% | 0% |
| Hydrochloric acid | 0.01% | 0% | 0% |
| Preservative | 0.0045% | 0% | 0% |
| Chelant | 0.0071% | 0.0071% | 0% |
| Structurant | 0.10% | 0.30% | 0.1% |
| Antifoam | 0.008% | 0.00% | 0% |
| Water | Balance | Balance | Balance |

¹Ester Quat 1: Mixture of bis-(2-hydroxypropyl)-dimethylammonium methylsulfate fatty acid ester, (2-hydroxypropyl)-(1-methyl-2-hydroxyethyl)-dimethylammonium methylsulfate fatty acid ester, and bis-(1-methyl-2-hydroxyethyl)-dimethylammonium methylsulfate fatty acid ester, where the fatty acid esters are produced from a C12-C18 fatty acid mixture (REWOQUAT DIP V 20M Conc, ex Evonik)
²Ester Quat 2: N,N-bis(hydroxyethyl)-N,N-dimethyl ammonium chloride fatty acid ester, produced from C12-C18 fatty acid mixture (REWOQUAT CI-DEEDMAC, ex Evonik)
³Ester Quat 3: Esterification product of fatty acids (C16-18 and C18 unsaturated) with triethanolamine, quaternized with dimethyl sulphate (REWOQUAT WE 18, ex Evonik)
*Core/shell delivery particles, where the shell comprises an acrylate polymer, and the core comprises fragrance and a portioning modifier (e.g., isopropyl myristate). The “% Active” provided is the amount of fragrance delivered to the composition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A container system comprising a container and a label,
wherein the container comprises:
a closed end having a closed end periphery,
a peripheral wall extending from the closed end periphery about a longitudinal axis of the container to an open end,
wherein the peripheral wall has a peripheral wall exterior surface oriented away from the longitudinal axis,
wherein the peripheral wall exterior surface has a peripheral wall exterior surface area,
wherein the peripheral wall exterior surface comprises a first smooth panel and a textured region,
wherein the first smooth panel does not encircle the longitudinal axis,
wherein the textured region comprises a plurality of irregularities,
wherein each irregularity is arranged next to one or more adjacent irregularities; and
wherein the label is in the form a sleeve disposed about the peripheral wall.

2. The container system according to claim 1, wherein the sleeve is a shrink sleeve.

3. The container system according to claim 1, wherein the smooth panel is disposed on a front wall of the peripheral wall.

4. The container system according to claim 1, wherein the container comprises a second smooth panel disposed on a rear wall of the peripheral wall, wherein the rear wall is opposite a front wall.

5. The container system according to claim 1, wherein the first smooth panel is curved about a single axis.

6. The container system according to claim 1, wherein the peripheral wall comprises side walls that connect a front wall to a back wall,
wherein at least a portion of the irregularities are disposed at least one side walls.

7. The container system according to claim 1, wherein the first smooth panel has a first smooth panel surface area that is from about 5% to about 50% of the peripheral wall exterior surface area.

8. The container system according to claim 1, wherein the textured region has a textured region surface area that is from about 5% to about 50% of the peripheral wall exterior surface area.

9. The container system according to claim 1, wherein the plurality of irregularities comprises a plurality of facets.

10. The container system according to claim 9, wherein each of the facets has a facet exterior surface oriented away from the longitudinal axis, and wherein each of the facets has a facet exterior surface area that is between about 0.0001% and about 4% of the peripheral wall exterior surface area.

11. A consumer product, wherein the consumer product comprises:
the container system according to claim 1, and
a consumer product composition disposed in the interior volume of the container.

12. An array of consumer products, wherein the array comprises a first consumer product and a second consumer product,
wherein the first consumer product comprises a first consumer product composition disposed in a first container,
wherein the second consumer product comprises a second consumer product composition disposed in a second container,
wherein the first container and the second container each comprise:
a closed end having a closed end periphery,
a peripheral wall extending from the closed end periphery about a longitudinal axis of the container to an open end,
wherein the peripheral wall has a peripheral wall exterior surface oriented away from the longitudinal axis,
wherein the peripheral wall exterior surface has a peripheral wall exterior surface area,
wherein the peripheral wall exterior surface comprises a first smooth panel and a textured region,
wherein the first smooth panel does not encircle the longitudinal axis,
wherein the textured region comprises a plurality of irregularities,
wherein each irregularity is arranged next to one or more adjacent irregularities;
wherein the first container comprises a first label in the form of a sleeve disposed about the peripheral wall, and
wherein the second container comprises a second label on the smooth panel,
wherein the second label is not in the form of a sleeve.

13. The array according to claim 12, wherein the second label is selected from the group consisting of an in-mold label, a heat-transfer label, an adhesive label, a direct-printed label, or a combination thereof.

14. The array according to claim 12, wherein the first consumer product composition and the second consumer product composition each comprise a first consumer product adjunct material in common.

15. The array according to claim 14, wherein the first consumer product adjunct material is a quaternary ammonium ester material.

16. The array according to claim 12, wherein the first and the second labels each comprise a common indicia.

17. The array according to claim 12, wherein the first and second consumer product compositions comprise different perfume systems.

18. The array according to claim 12, wherein the first and second consumer product compositions are both liquids.

19. The array according to claim 12, wherein the first and second consumer products are displayed on a common shelving system, preferably in a commercial setting.

20. The array according to claim 12,
wherein the first container comprises a first closure,
wherein the second container comprises a second closure, and
wherein the first and the second closures are characterized by different sizes, different shapes, different colors, or a combination thereof.

21. A method of manufacturing the first and second consumer products according to claim 12, wherein the method comprises the steps of:
providing the first consumer product composition to the first container;
providing the label in the form of the sleeve to the peripheral wall of the first container;
providing the second consumer product composition to the second container; and
providing the label that is not in the form of a sleeve to the smooth panel of the second container.
